(19) United States
(12) Patent Application Publication
(10) Pub. No.: US 2026/0285701 A1
(43) Pub. Date: Sep. 24, 2026

(54) TWO-DIMENSIONAL NANOSHEET AND PREPARATION METHOD THEREFOR

(71) Applicant: SOOCHOW UNIVERSITY, Suzhou (CN)

(72) Inventors: Fengxia GENG, Suzhou (CN); Jinpeng JI, Suzhou (CN)

(21) Appl. No.: 18/998,491

(22) PCT Filed: Aug. 4, 2022
(86) PCT No.: PCT/CN2022/110357

§ 371 Date: Oct. 27, 2025

(51) Int. Cl. C01G 19/02; B82Y 40/00; C01G 30/00

(52) U.S. Cl. CPC C01G 19/02; C01G 30/002; B82Y 40/00; C01P 2004/20; C01P 2004/61

(57) ABSTRACT

A preparation method for a two-dimensional nanosheet. The method includes: performing a calendering treatment on non-Van der Waals layered crystal particles, and then performing mechanical exfoliation, so as to obtain a two-dimensional nanosheet. Mechanical exfoliation is commonly referred to as a scotch tape method, and mechanical exfoliation may only be performed by using an adhesive tape (sometimes, the assistance of an interposer is required) when the interlayer interaction of a bulk material is dominated by a weak van der Waals force; however, there is significant electron density overlapping between layers of many functional materials with layered stacked crystal structures, and the electron density overlapping forms a non-Van der Waals structure, which cannot be directly exfoliated by using the adhesive tape. In the present method, few-layer or even single-layer structures of various non-Van der Waals layered crystal materials are successfully obtained for the first time by means of a calendering pretreatment combined with mechanical exfoliation; in addition, a new physical phenomenon can be observed in an exfoliated two-dimensional crystal.

### TECHNICAL FIELD

The present invention belongs to nanotechnology and specifically relates to a two-dimensional nanosheet and its preparation method.

### BACKGROUND TECHNOLOGY

Two-dimensional materials, with thicknesses of just a few atomic layers or even a single atomic layer, have attracted significant interest in recent years. Limiting their thickness to sub-nanometer levels endows these materials with a lot of novel physical properties and applications related to their dimensions (Novoselov, K. S.; Geim, A. K.; Morozov, S. V.; Jiang, D.; Zhang, Y.; Dubonos, S. V.; Grigorieva, I. V.; Firsov, A. A. Electric Field Effect in Atomically Thin Carbon Films. Science 2004, 306, 666-669. Tan, C.; Cao, X.; Wu, X.; He, Q.; Yang, J.; Zhang, X.; Chen, J.; Zhao, W.; Han, S.; Nam, G. H.; Sindoro, M.; Zhang, H. Recent Advances in Ultrathin Two-Dimensional Nanomaterials. Chem. Rev. 2017, 117, 6225-6331. Butler, S. Z.; Hollen, S. M.; Cao, L.; Cui, Y.; Gupta, J. A.; Gutierrez, H. R.; Heinz, T. F.; Hong, S. S.; Huang, J.; Ismach, A. F.; Johnston-Halperin, E.; Kuno, m.; Plashnitsa, V. V.; Robinson, R. D.; Ruoff, R. S.; Salahuddin, S.; Shan, J.; Shi, L.; Spencer, M. G.; Terrones, M.; et al. Progress, Challenges, and Opportunities in Two Dimensional Materials beyond Graphene. ACS Nano 2013, 7, 2898-2926. Zhou, J.; Lin, J.; Huang, X.; Zhou, Y.; Chen, Y.; Xia, J.; Wang, H.; Xie, Y.; Yu, H.; Lei, J.; Wu, D.; Liu, F.; Fu, Q.; Zeng, Q.; Hsu, C. H.; Yang, C.; Lu, L.; Yu, T.; Shen, Z.; Lin, H.; Yakobson, B.; Liu, Q.; Suenaga, K.; Liu, G.; Liu, Z. A Library of Atomically Thin Metal Chalcogenides. Nature 2018, 556, 355-361.). Mechanical exfoliation, often referred to as the Scotch tape method, is considered the best approach for obtaining high-quality two-dimensional materials while preserving their intrinsic structure and characteristics due to the absence of chemical reactions during the process. Introducing an auxiliary interlayer (such as Au, Al₂O₃, etc.) can be used to enhance the adhesion between the substrate and the target crystal and increase the contact area, thus enabling the exfoliation of large-sized nanosheets. However, this method requires selecting different intermediate materials for different exfoliation targets, and especially after exfoliation, complex methods are needed to remove the intermediate materials, which can introduce impurities that significantly limit the intrinsic properties of two-dimensional materials. Moreover, only when the interlayer interactions in bulk materials are dominated by weak van der Waals (vdW) forces, can tape (sometimes with the assistance of an intermediate layer) be used for mechanical exfoliation (Deng, Y.; Yu, Y.; Song, Y.; Zhang, J.; Wang, N.; Sun, Z.; Yi, Y.; Wu, Y.; Wu, S.; Zhu, J.; Wang, J.; Chen X.; Zhang, Y. Gate-Tunable Room-Temperature Ferromagnetism in Two-Dimensional Fe₃GeTe₂. Nature 2018, 563, 94-99). After the first successful mechanical exfoliation of graphene, single-layer structures of hexagonal boron nitride (h-BN), transition metal dihalides (TMD), metal-organic frameworks (MOF), and black phosphorus (BP) were also reported. It is worth noting that many functional materials have a layered stacked crystal structure, but there is significant electron density overlap between layers. For example, some metal oxides can be viewed as stacks of rigid layers, where each layer consists of metal-oxygen polyhedra connected by edges or corners and extending in a two-dimensional manner. Adjacent layers in these structures usually have metallic or electrostatic attraction, known as non-van der Waals structures (non-vdW), with interlayer interactions significantly higher than those in van der Waals layered structures. Due to the strong electronic coupling between adjacent layers, these materials cannot be directly mechanically exfoliated into a single or few layers. From the perspective of structure-property relationship and potential applications of new two-dimensional analogs, mechanical exfoliation of such non-van der Waals materials is interesting and important. Therefore, it is necessary to develop a method for mechanical exfoliation of non-van der Waals layered structures.

### Technical Issues

The method of the present invention includes a simple calendering pretreatment, followed by mechanical exfoliation with Scotch tape to obtain thin layers; it successfully exfoliates various materials, including metals (Bi. Sb), semiconductor metal oxides and sulfide (SnO, V₂O₅, Bi₂O₂Se), as well as superconducting compounds (KV₃Sb₅). Theoretical calculations of electron density have confirmed strong electronic coupling between these structural layers, and the exfoliation energy is typically several times higher than that of graphite, which naturally makes the conventional exfoliation of these materials difficult, even impossible.

### Technical Solutions

The present invention adopts the following technical solution: a method for preparing two-dimensional nanosheets, wherein the crystal particles are subjected to calendering pretreatment and then mechanically exfoliated to obtain two-dimensional nanosheets; preferably, the crystal particles are laid flat before calendering pretreatment and then mechanically exfoliated to obtain two-dimensional nanosheets.

In this invention, the crystal particles are non-van der Waals layered structure crystal particles, such as metal particles, semiconductor metal oxide particles, chalcogenide particles, superconducting compound particles, etc. For example, the crystal particles can be metals (Bi, Sb), semiconductor metal oxides and sulfide (SnO, V₂O₅, Bi₂O₂Se), and superconducting compounds (KV₃Sb₅); preferably, the particle size of the crystal particles is in the level of micrometer to millimeter, such as 1 μm to 5 mm, more preferably 1 to 500 μm, and further preferably 10 to 200 μm.

In this invention, a roller or a rod is used for calendering treatment. Preferably, the calendering load is 0.5 to 10 Kg, and the speed is 10 to 300 mm/min. For van der Waals structured crystals, such as graphite, two-dimensional nanosheets can be obtained through conventional mechanical exfoliation. However, for non-van der Waals structured crystal particles with strong interlayer interactions, it is impossible to obtain two-dimensional nanosheets through conventional mechanical exfoliation. This invention innovatively proposes calendering followed by conventional mechanical exfoliation to obtain two-dimensional nanosheets, with thicknesses ranging from 0.1 nm to 50 nm, particularly from 0.1 nm to 30 nm, especially from 0.3 nm to 10 nm, and more importantly, from 0.5 nm to 5 nm.

In this invention, mechanical exfoliation is achieved through tape exfoliation. The method involves using a tape to adhere the particles, folding them, pressing them together, and then exfoliating them off, and the thin material will be stuck to the tape. This method is a conventional technique. Existing technologies use this method to exfoliate graphite to obtain graphene. However, direct tape exfoliation cannot reduce the thickness of non-van der Waalslayered crystal structures or produce nanoscale sheets, let alone single-layer or few-layer two-dimensional nanosheets.

In this invention, the calendering is unidirectional calendering, which is a conventional understanding. For example, the rolling of the crystal particles in a unidirectional direction, not calendering the crystal particles in a unidirectional direction back and forth.

As an example, crystal particles are laid flat on the base plate of an electric calendering roller device, then unidirectionally and single-roller calendered to obtain calendered particles; the calendered particles are then stuck with Scotch tape and exfoliated off to get a thin layer, which is the two-dimensional nanosheet product of this invention. This can be used to prepare materials for assembling two-dimensional nanosheets, such as superconducting materials, optical materials, electrode materials, thermal conductive materials, and electrical conductive materials.

### Beneficial Effects

This invention uses calendering pretreatment, followed by the exfoliation by Scotch tape, successfully obtaining few-layer and even single-layer structures of several materials for the first time, and exciting new phenomena can be observed in the exfoliated two-dimensional materials. Antimony metal becomes a semiconductor with a band gap of 2.01 eV; the light absorption range of semiconductor SnO can be tuned from the infrared region (IR) to the ultraviolet region, with the band gap changing from 0.60 eV in bulk to 3.65 eV in a single layer. Additionally, KV₃Sb₅ thin sheets are a very promising two-dimensional superconducting material. Therefore, the new results of this invention propose a general method for the mechanical cleavage of non-van der Waals layered materials and provide a variety of new 2D materials.

### ILLUSTRATION OF THE DRAWINGS

FIG. 1 (a) shows the exfoliation energy (meVÅ⁻²) of the non-van der Waals layered material studied in the present invention; The values of graphite are also listed for reference. The exfoliation energy of non-van der Waals layered structures is typically 1.3 to 3.6 times that of graphite (within the vdW force range). According to the reference (Nano Lett. 2018, 182759-2765), the exfoliation energy is calculated as the difference in ground-state energy between bulk materials (each atomic layer) and individual deviated layers. (b) shows the contour lines of electric density difference for representative structures of the material of the present invention, revealing strong interlayer coupling; red and blue contour lines represent electron accumulation and depletion, respectively. (c) shows the corresponding AFM images, indicating that these materials are single or few-layer.

FIG. 2 shows the theoretical stability prediction for exfoliating a single layer of SnO. (a) Side and top views of SnO. (b) Isoelectric contour lines for the charge density difference in SnO crystal structure, indicating reduced interlayer electron density and weakened interlayer interactions; red and blue regions represent electron accumulation and depletion, respectively. (c) Harmonic phonon dispersion spectrum of a single layer of SnO. (d) Changes in temperature (upper left) and total energy (lower left) over trajectory time, obtained from molecular dynamics simulations of a single layer of SnO at 300 and 600 K; right figure: corresponding snapshot at the end of the molecular dynamics simulation. (e) The minimum energy path for O₂ dissociation on SnO layers was calculated using the density functional theory based climbing elastic band (CI-NEB) method. Illustration: Representative CI-NEB configurations along the path, including the initial state of stable adsorption of molecular oxygen, transition state, and final state of free atomic oxygen. The calculated O₂ dissociation potential barrier is 0.58 eV, indicating that SnO sheets have good stability against O₂ attacks under normal conditions.

FIG. 3 shows the characterization of crystal structures before and after calendering. (a) XRD pattern of SnO crystals and (b) Raman spectrum. The calendered SnO crystals are denoted as M-SnO. SEM images of SnO crystals (c) before calendering and (d) after calendering. Each figure includes a schematic diagram of the stacking. (e) Lateral forces on SnO measured by AFM. Schematic illustration: experimental diagram. (f) STEM images of cross-sectional of SnO and M-SnO crystals.

FIG. 4 shows the characteristics of SnO sheets of different thicknesses. (a) Typical optical microscope images of the SnO layer exfoliated off from a glass substrate. (b-f) Representative AFM images of SnO sheets with 1-5 layers. (g) High-resolution TEM images of SnO sheets. (h) Comparison of Raman spectra of single-layer SnO with bulk SnO, and with Raman spectra after exposure to air for 3 months and additional heating to 200° C.; laser wavelength: 532 nm.

FIG. 5 shows (a) Raman spectroscopy of SnO sheets; illustration: optical image of nanosheets. (b) A_{lg} and (c) E_{g} are Raman intensity mapping maps collected over an area of 15×15 μm² with a step size of 500 nm. The results shows that the thickness was uniform and the local bonding structure was good.

FIG. 6 shows the AFM images of SnO sheets on Si/SiO₂ substrates before and after exposure to ambient air for 3 months, as well as after additional heating in air at 200° C.

FIG. 7 shows the comparison of physical properties between single-layer SnO sheets and SnO bulk. (a) band structure, (b) the band gap experimentally estimated by plotting the relationship between (Ahv)^{1/2} and hv, with the experimental and fitted values indicated by solid and dashed lines, respectively. Band gap modulation covers the entire spectral range from infrared to ultraviolet. (c) Experimental estimation of the band structure and (d) band gap of antimony. When reduced to a single layer, bulk metallic materials transform into semiconductors with a band gap of 2.01 eV. (e) Comparison of the band gap modulation range from bulk to single-layer SnO and Sb with other reported two-dimensional semiconductors.

FIG. 8 shows (a) the optical transmittance of SnO nanosheets analyzed by UV-visible (UV-Vis) absorption and (b) absorbance. Spectra were collected on individual thin sheets deposited on a transparent quartz substrate using a UV-visible spectrometer with a laser spot radius of 2 μm; illustration (a): optical images of individual sheets and large bulks of SnO crystals. Arrows indicate increased thickness. (c) Variation diagram of band gap over thickness.

FIG. 9 shows the characteristics of Bi materials. (a-b) Representative SEM images and (c) X-ray diffraction spectra. Bismuth powder was purchased from Aladdin Industries Co., LTD. The lateral size of the microcrystals was about 50 μm.

FIG. 10 shows the characteristics of Sb material. (a-b) Representative SEM images and (c) X-ray diffraction pattern. Sb powder was purchased from Aladdin Industry Co., LTD. The lateral size of the microcrystals was about 60-80 μm.

FIG. 11 shows the characteristics of V₂O₅ material. (a-b) Representative SEM images at different magnifications and (c) X-ray diffraction patterns. Vanadium pentoxide powder was purchased from Aladdin Industries Co., LTD. The lateral size of the microcrystals was about 150 μm.

FIG. 12 shows the characteristics of Bi₂O₂Se material. (a-b) Representative SEM images at different magnifications and (c) X-ray diffraction patterns. Bi₂O₂Se powder was purchased from Aladdin Industrial Co., LTD. The lateral size of the microcrystals was about 50 μm.

FIG. 13 shows the characteristics of the single crystal KV₃Sb₅ material. (a-b) Representative SEM images at different magnifications. (c) X-ray diffraction pattern.

FIG. 14 is (a) AFM images of Sb nanosheets on Si/SiO₂ substrates; from left to right: freshly exfoliated sheet, sheet exposed to air for 3 months, and sheet heated additionally for 10 minutes at 200° C., as well as (b) corresponding Raman spectra. No significant changes were observed in the morphology, thickness, or spectral characteristics of the sheets, indicating their excellent stability of resistance to O₂.

FIG. 15 is (a) AFM images of Bi nanosheets on the Si/SiO₂ substrate; from left to right: freshly exfoliated sheet, sheet exposed to air for 3 months, and sheet heated for an additional 10 minutes at 150° C. and 200° C., respectively, as well as (b) corresponding Raman spectra. At temperatures up to 150° C., no significant changes were observed in the morphology, thickness, or spectral characteristics of the nanosheets, indicating that Bi nanosheets exhibit excellent stability of resistance to O₂.

FIG. 16 is (a) AFM images of Bi₂O₂Se sheets on the Si/SiO₂ substrate; from left to right: freshly exfoliated sheet, sheet exposed to air for 3 months, and sheet heated for 10 minutes at 200° C., as well as (b) corresponding Raman spectra. No significant changes in the morphology, thickness, or spectral characteristics of the sheet were observed, indicating that Bi nanosheets have excellent stability of resistance to O₂.

FIG. 17 shows a representative AFM image of KV₃Sb₅ with a thickness less than 2 nm (one or two layers).

FIG. 18 shows a representative optical microscope image of SnO sheets directly exfoliated off from the slide substrate (captured in transmission mode), showing that these layered crystals are still thick and opaque.

### THE EMBODIMENT OF THE INVENTION

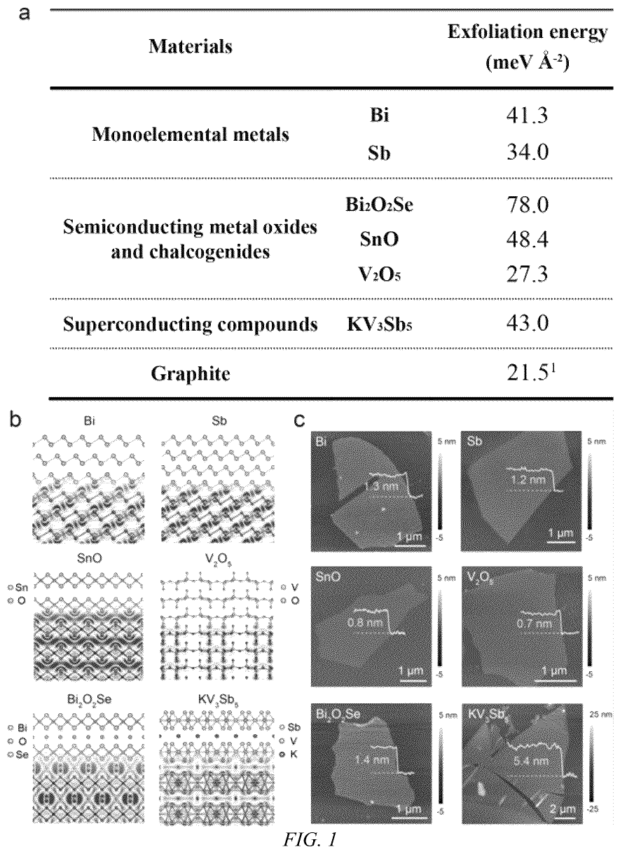

The exfoliation energy of non-van der Waals layered structures is typically several times higher than that of graphite (FIG. 1a), which naturally makes the exfoliation of these materials more challenging. The method of this invention includes a simple calendering pretreatment, followed by mechanical exfoliation using Scotch tape to obtain thin layers. This method successfully exfoliates various materials, including metals (Bi, Sb), semiconductor metal oxides and chalcogens (SnO, V₂O₅, Bi₂O₂Se), as well as superconducting compounds (KV₃Sb₅). Electron density calculations have verified the strong electronic coupling between these structural layers (FIG. 1b-c). This invention uses calendering pretreatment followed by Scotch tape exfoliation, achieving for the first time the successful preparation of few-layer and even single-layer structures of multiple materials, and exciting new phenomena can be observed in the exfoliated 2D materials. Antimony has become a semiconductor with a band gap of 2.01 eV; the light absorption range of the semiconductor SnO can be tuned from the infrared region (IR) to the ultraviolet region, with the band gap changing from 0.60 eV in bulk to 3.65 eV in a single layer. Additionally, thin KV₃Sb₅ is a two-dimensional superconductor with potential. Therefore, the new results of this invention propose a general method for mechanical stratification of non-van der Waals layered materials, and provide a variety of new 2D materials.

SnCl₂·2H₂O and NaOH were purchased from Sinopharm Chemical Reagents Co., LTD. V₂O₅ (metal-based, 99.99%), Bi (metal-based, 99.99%) and Sb (metal-based, 99.99%) were purchased from Aladdin Industries Co., LTD. (Shanghai, China). Bi₂O₂Se (metal-based, 99.99%) was purchased from Nanjing Nuken Nano Technology Co., Ltd. (Limited Company). All reagents did not require purification. Scotch tape was purchased from Taizhou Sunano New Energy Co., Ltd. Heat release tape (single-sided, heat release temperature 120° C.) was purchased from Jiangsu Xianfeng Nanomaterial Technology Co., Ltd. Polydimethylsiloxane film (0.5 mm) was purchased from Luoyang Atmel Trading Co., Ltd. Si/SiO₂ substrate (SiO₂ thickness: 300 nm) was provided by Beijing EMCN Technology Co., LTD.

Material Testing. The crystal structure of the samples was studied using a powder X-ray diffraction system (XRD, X'Pert-Pro MPD) equipped with a Cu/Kal target (2=1.5418 Å). The morphology of the samples was investigated using a scanning electron microscope (SEM, Hitachi SU8010). Under ultra-high vacuum conditions, the surface chemical state of the sample was tested using an Al/Kα target on an Escalab 250Xi X-ray photoelectron spectrometer (Thermo Fisher Scientific Inc.), with a standard deviation of 0.1 eV for binding energy. Atomic force microscopy (AFM; Bruker Instruments Dimension ion) was used to characterize the lateral size and thickness of the thin films on a silicon substrate. High-resolution transmission electron microscopy (HR-TEM) was performed using a FEI Tecnai G2 F20 S-TWIN TMP, which was equipped with a field emission gun operating at an accelerating voltage of 200 kV. The mechanically exfoliated thin films were directly transferred onto a copper grid, and atomic images were collected using a Themis-defocused scanning transmission electron microscope (STEM, HF5000). Samples were prepared using a focused ion beam (FIB), where high-current gallium ion beams were used to exfoliate surface atoms for micro-nano surface morphology processing. The UV-visible near-infrared transmittance spectra of the exfoliated thin sheets on a transparent quartz slide were recorded at 20/30 PV, and differential photometry was performed at room temperature to calculate band gap values using Tauc diagrams (Craic Technologies Inc.), with a measurement wavelength range of 350-2000 nm. Raman spectroscopy (WITec Alpha 300R) was collected using a confocal Raman spectrometer equipped with an UHTS 300 spectrometer (600 lines per millimeter grating) and CCD detector (DU401A-BV-352), under laser excitation at 532 nm (power: 1 mW), with a spot radius of 2 μm. The laser beam was focused by a 100× objective and the Raman signal was collected, and the exfoliated sheet was transferred to Si/SiO₂ substrate.

Synthesis example: preparation of SnO crystal particles. In a typical process, 0.02 mol (4.50 g) of SnCl₂·2H₂O was dissolved in 70 mL of ultrapure water with stirring, and then NaOH was added until the pH of the mixture reached 9. After further stirring for 30 minutes, the mixture was transferred to a 100 mL high-pressure reactor lined with polytetrafluoroethylene, then it was sealed, and heated at 150° C. for 15 hours. Then it was cooled naturally to room temperature. The product was collected by centrifuging the mixture, and then it was washed three times alternately with distilled water and anhydrous ethanol, and dried overnight in vacuum to obtain blue-black SnO crystals.

Single crystal KV₃Sb₅ was prepared by using the flux method with KSb₂ alloy as flux to grow. K, V, Sb elements and KSb₂ precursor were sealed in a tantalum crucible at a molar ratio of 1:3:14:10, then sealed in a high-vacuum quartz ampoule. The ampoule was heated to 1273 K and held for 20 hours, followed by cooling to 773 K. Single crystals with silver luster with a lateral size of about 1000 μm was separated from the flux by centrifugation.

This invention first calendered the crystal particles, then mechanically exfoliated them off using Scotch tape to prepare the material, and then they were transferred onto the target substrate using the full dry method of existing technology. As an example, the invention laid out the crystal particles flat and rolled them on the surface, applying shear force to the crystals. The rolling was in one direction (not back-and-forth), resulting in continuous and unidirectional calendering. The roller or rod had a load of 0.5 to 10 kg and a speed of 10 to 500 mm/min. Then, according to conventional methods: the rolled crystal particles were exfoliated off using Scotch tape, forming a thin layer (i.e., the two-dimensional nanosheet of this invention), and the thin layer was separated from the Scotch tape using a thermal release tape. The thin layer was then transferred to a polydimethylsiloxane film by heating, or it could be further pressed vertically onto the target substrate, transferring the exfoliated thin layer to various substrates such as glass, silicon, or silicon/silica; alternatively, the steps of using a thermal release tape and/or a polydimethylsiloxane film for transfer could be omitted. In this invention, the specific method of laying out the particles is conventional technology, not limited, and does not affect the realization of the technical effects of this invention.

### Examples 1

The crystal particles were placed between two sheets of paper, then a plastic rod was manually pressed and rolled on the surface in one direction to obtain the calendered particles; next, the conventional classic tape exfoliation method was used, i.e. sticking the calendered particles with transparent tape, folding and pressing them, then exfoliation to form a thin layer material, i.e., the two-dimensional nanosheets of this invention. Then, dry at 100° C. for 5 seconds (to help maintain the lateral size of the sheet), and use a heat release tape to separate the thin layer from the Scotch tape. Finally, according to testing requirements, release at 150° C. and transfer the sheet to different substrates.

The crystal particles were metal Bi, metal Sb, semiconductor metal oxide SnO, V₂O₅, Bi₂O₂Se, superconducting compound KV₃Sb₅.

### Examples 2: Performance Characterization of Two-Dimensional SnO Nanosheets

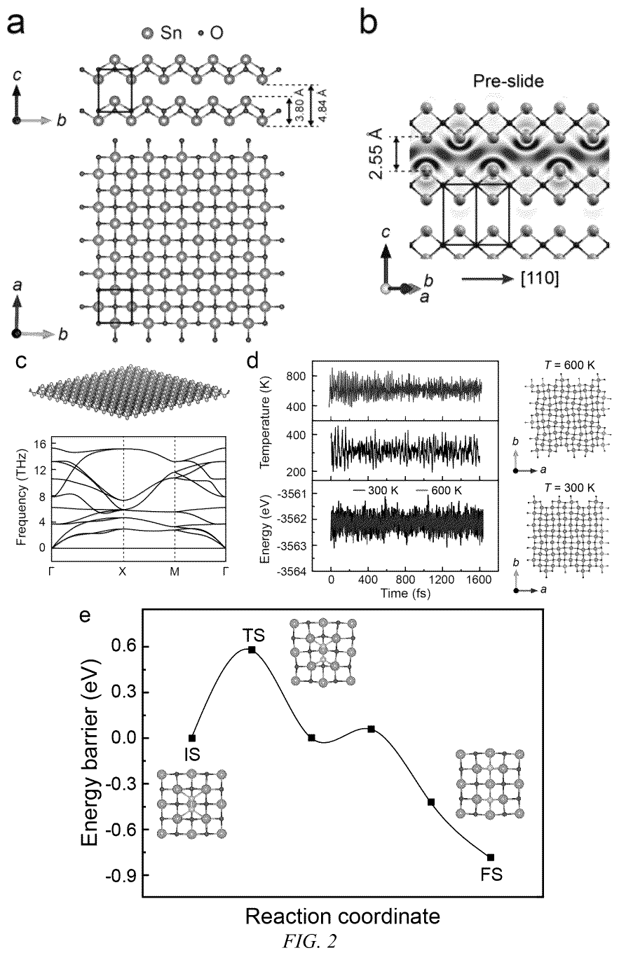

The crystal structure of SnO belongs to the P4/nm space group and has a tetragonal crystal cell structure. Sn and O atoms are alternately arranged in the crystal direction in the order of Sn_{1/2}—O—Sn_{1/2} to form a layered sequence (FIG. 2a). Each O atom is coordinated with four surface metal Sn atoms to form Sn₄O tetrahedron. Therefore, the lone pair electrons composed of Sn 5s orbitals point towards the interlayer spacing, resulting in strong dipole-dipole interactions between adjacent SnO layers. The differential charge density map of this structure shows high electron density between layers, indicating strong interlayer interactions (FIG. 2b). Due to the strong binding interaction between adjacent layers with a high exfoliation energy of 48.4 meVÅ⁻² (quantified by the difference in ground state energy between bulk materials and single-layer of existing technology), it is not possible to produce single-layer sheets through conventional mechanical exfoliation. This invention involves exfoliation off a single-layer SnO sheet from SnO crystal particle, where the nanosheet exhibits an unusual metallic cover structure with two Sn atomic layers sandwiching one O atomic layer. The crystallographic thickness of the SnO single layer is 0.38 nm. Calculated single-layer SnO phonon spectra show that all phonon branches in the entire Brillouin region are positive, with no imaginary frequencies (FIG. 2c), indicating structural stability of the 2D SnO sheet in its ground state. Further studies have been conducted on the stability of this single-layer nanosheet to environmental or oxidative environments and temperatures, as this is crucial for fundamental research and technological applications. Theoretical estimation of oxidation potential barrier using the climbing elastic band method calculated by DFT show that SnO sheets have stability and can resist O₂ attack (FIG. 2e). Molecular dynamics simulations at temperatures of 300 and 600 K show no significant structural dissociation (FIG. 2d), indicating that the exfoliated SnO sheets exhibit high thermal stability. These findings strongly suggest that once separated from the stacked layers of large crystals, monolayer 2D SnO is stable.

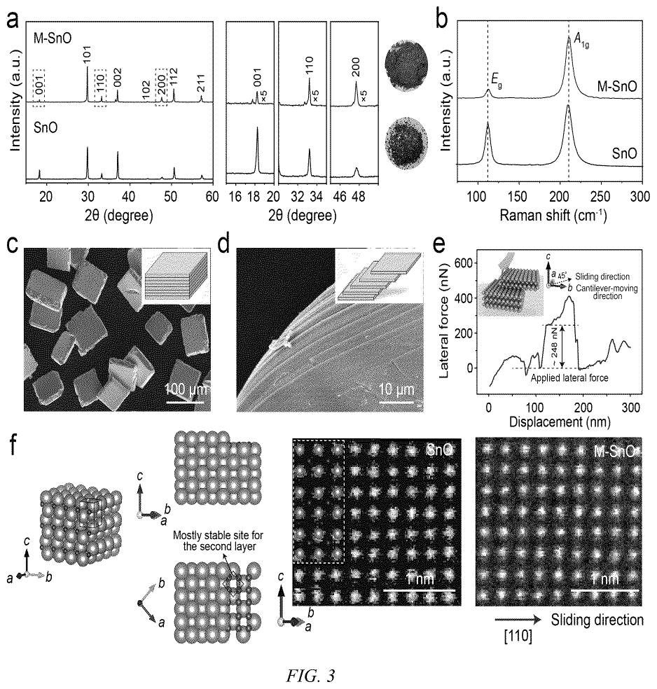

The invention prepared SnO crystal particles through the hydrothermal reaction of stannous chloride dihydrate and sodium hydroxide (refer to detailed information in the synthesis example). The X-ray diffraction (XRD) pattern of the crystals after the hydrothermal reaction shows diffraction peaks that can be indexed to a tetragonal unit cell with lattice parameters a=b=3.8016 (4) Å, c=4.8441 (5) Å (FIG. 3a), indicating the formation of pure phase SnO under these conditions. X-ray photoelectron spectroscopy (XPS) confirmed the presence of Sn and O elements, with a Sn/O ratio close to 1. The high-resolution Sn 3d spectrum shows two significant peaks at 486.1 and 494.5 eV, corresponding to the Sn 3d_{5/2} and Sn 3d_{3/2} core energy levels of Sn²⁺, respectively. The valence state is also consistent with the blue-black color of the crystal (see FIG. 3a for illustration). The Raman spectrum of the original crystal shows E_{g} at 112 cm⁻¹ and A_{lg} peak at 210 cm⁻¹, which is a characteristic of SnO structure (FIG. 3b). Scanning Electron Microscopy (SEM) shows that the lateral size of SnO crystal is 100 μm, with a thickness of about 10 μm (FIG. 3c). The sheet-like shape may be related to the inherent anisotropic layered structure, whose thickness is associated with the stacking of layers. Simple calendering treatment of these crystals can alter the SnO crystal structure, known as M-SnO. SEM morphology characterization reveals planar sliding (FIG. 3d), and a new diffraction peak is observed in the low-angle region of the XRD pattern, indicating that the interlayer spacing increases slightly from 4.844 Å to 4.949 Å (FIG. 3a). FIG. 3e shows in-situ AFM. FIG. 3f shows scanning transmission electron microscopy (STEM) revealing repulsion between adjacent layers and an increase in the repetition distance along the stacking direction. No vacancies are observed at the Sn sites. The in-plane Sn—Sn distance varies slightly from 2.684 Å to 2.715 Å, which is consistent with XRD results. After calendering treatment, the intensity of the in-plane Raman vibration mode E_{g} significantly decreased (FIG. 3b).

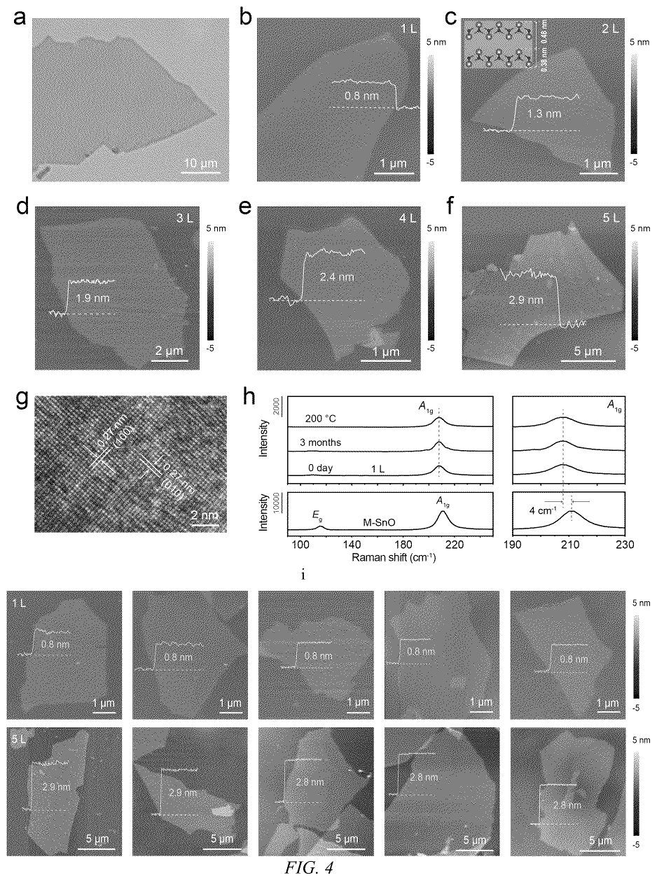

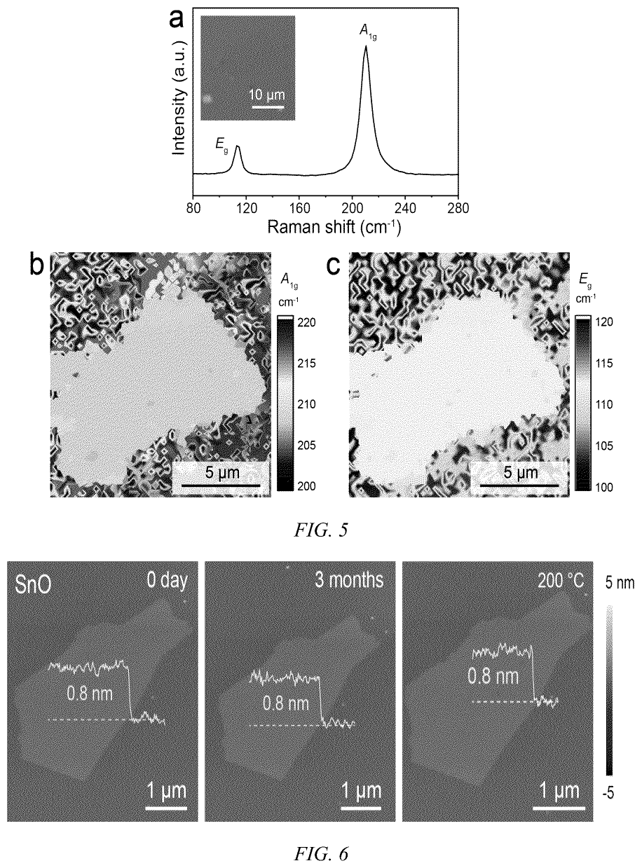

In the method disclosed in this invention, after calendering treatment, the crystals can be exfoliated off and layered into individual SnO sheets using conventional Scotch tape methods; optical microscope images of the exfoliated SnO sheets transferred onto transparent glass substrates show high transparency (FIG. 4a). The number of layers is verified by AFM, as shown in FIGS. 4b-f. The minimum thickness of the two-dimensional SnO sheets measured by AFM is 0.8 nm, and based on their crystal structure, the thickness of a single SnO layer is 0.38 nm. Considering the 0.1-0.6 nm interface “ineffective layer” typically present between the peeled sheet and the substrate, the measured height of 0.8 nm does not correspond to two or more layers but should correspond to a single layer of SnO. Layers of different thicknesses were measured, specifically 1.3, 1.8, 2.4, and 2.9 nm, with the thickness increasing in the step of about 0.5 nm, as illustrated in the illustration of FIG. 4c. The ideal step size is the crystal repetition distance between adjacent layers (0.48 nm), which perfectly matches the experimentally measured step size. Therefore, these sheets correspond to layers of 2, 3, 4, and 5. The size of the exfoliated sheets in this invention is at the level of millimeter, with single-layer sheets measuring 2 to 6 μm, and five-layer sheets increasing to about 15 μm (FIGS. 4b-i). This can meet the requirements for fundamental research applications on inherent material properties and certain devices. High-resolution transmission electron microscopy (TEM) shows cross-lattice fringes with a spacing of 2.7 Å, corresponding to the lattice fringe spacing on the (110) plane (FIG. 4g). Upon careful examination of the image, no obvious defects are found, indicating that there are not too many metal vacancy defects generated during the calendering process. In Raman spectrum, the intensity of the in-plane vibration mode E_{g} rapidly decreases with decreasing sample thickness, making it almost undetectable for a single layer (FIG. 4h). The A_{lg} peak shows a red shift (~4 cm⁻¹), and as the number of layers decreases, the vibration mode in the layered structure softens. The Raman intensity mapping of E_{g} and A_{lg} modes on a single sheet further confirms the high uniformity of thickness and local bonding structure (FIG. 5). It is worth noting that even after exposing the sample to air for more than 3 months and heating it to an additional 200° C., no characteristic peak of SnO₂ was observed, which confirms the structural stability of peeled SnO sheets under environmental conditions. AFM studies confirm that the morphology and thickness of the sheets remain intact (FIG. 6).

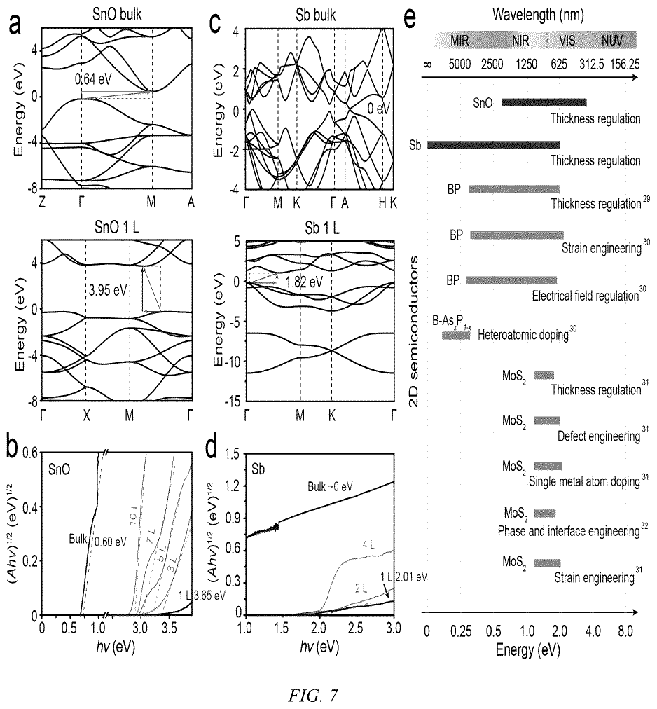

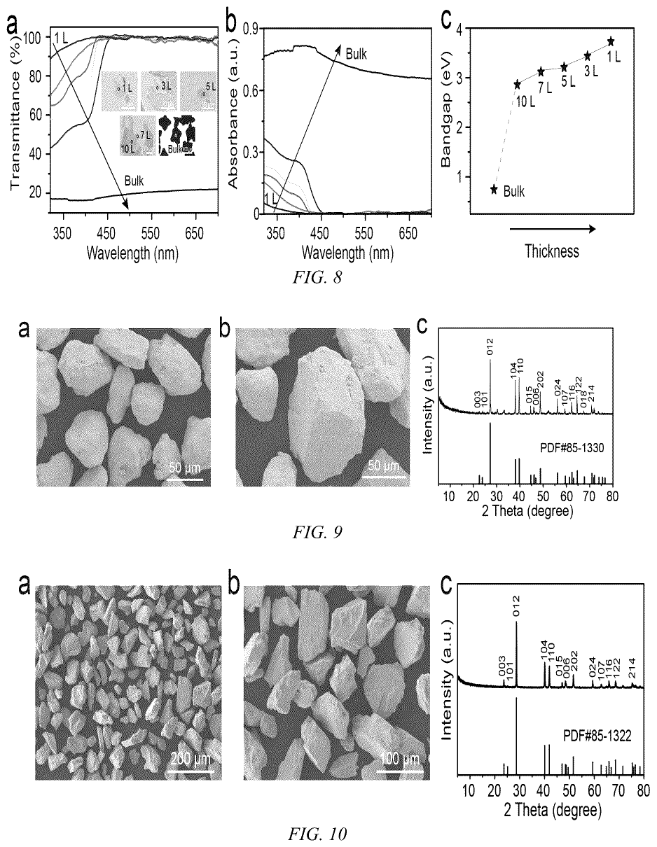

After the bulk SnO crystal is exfoliated into a thin sheet, its physical properties undergo significant changes. Theoretical predictions indicate that the band gap increases significantly from 0.64 eV in bulk SnO to 3.95 eV in a single layer (FIG. 7a). Experimentally, the absorption spectrum of the SnO sheet exhibits the characteristic shape of a semiconductor with distinct absorption edges (FIG. 8), which is consistent with theoretical estimates. As the thickness of the nanosheet decreases, the band gap of the SnO sheet continues to increase (FIG. 7b), with band gap modulation spanning the entire spectral range from infrared to ultraviolet. This very wide absorption window is the largest absorption window reported for 2D semiconductors to date (FIG. 7e).

Use the optical microscope attachment on the instrument to select an appropriate sample position based on the contrast difference between the substrate and the layered plate. Compared to the highly transparent exfoliated thin sheets, the original large crystal blocks appear black due to their opacity. Thinner sheets exhibit higher transparency. Based on the Tauc diagram of (α hv)^{1/2} and HV, where a represents the absorption coefficient, h is the Planck constant, and v is the incident photon frequency, the optical band gap value is extracted by extrapolating the fitted line to the intercept (α=0).

### Examples 3: Physical Properties of Other Material Sheets Obtained by the Present Invention

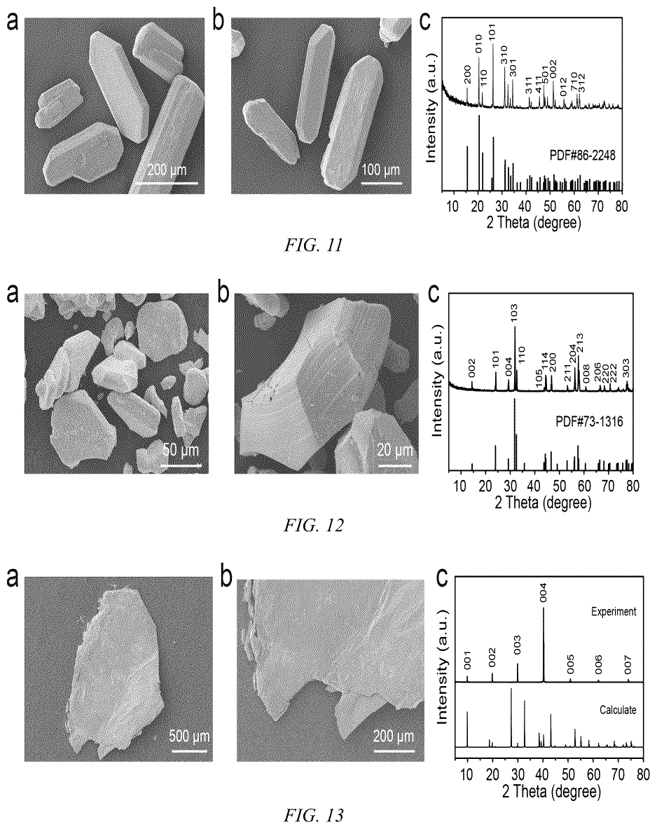

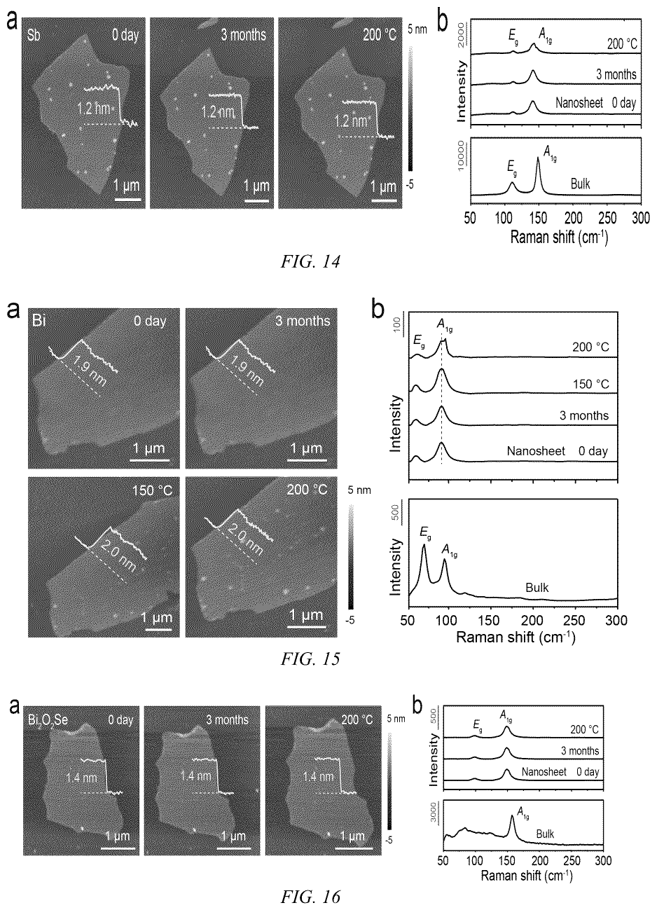

This invention can be applied to various materials, including metals (Bi, Sb), semiconductor metal oxides and chalcogens (SnO, V₂O₅, Bi₂O₂Se), as well as superconducting compounds (KV₃Sb₅); interlayer interactions and corresponding AFM images are shown in FIGS. 1b and c. Specifically, antimony (Sb) is a three-dimensional pseudo-layered crystal belonging to the R3-mh space group, with triangular and hexagonal lattices. This crystal can be viewed as ABCABC-stacked layers of bent honeycomb-arranged antimony atoms. Notably, the minimum interlayer spacing is only 0.23 nm, indicating that interlayer interactions are primarily chemical (as shown in the structure and density maps in FIG. 1b), making direct mechanical exfoliation difficult. Using the method of this invention, a single layer of Sb can be obtained at a thickness of 1.2 nm. FIGS. 9-13 provide characterization details for antimony and other exemplary materials. The nanosheets exfoliated off from these materials (including Bi, Sb, and Bi₂O₂Se) exhibit long-term antioxidant stability even when additionally heated in air (FIG. 14-16). Importantly, when reduced to a single layer with a thickness of 1.2 nm, antimony metal is transformed into a wide-band gap semiconductor (2.01 eV) (FIG. 7c, d). The broad modulation of physical properties with thickness in this invention may be related to strong electronic coupling in the interlayer regions. In non-van der Waals structures, as the number of layers decreases, strong interlayer interactions lead to subtle changes in the lattice structure, which affect the physical properties of exfoliated sheets. The unique thickness-property relationship observed in these materials further highlights the importance of extending 2D sheets to non-van der Waals materials.

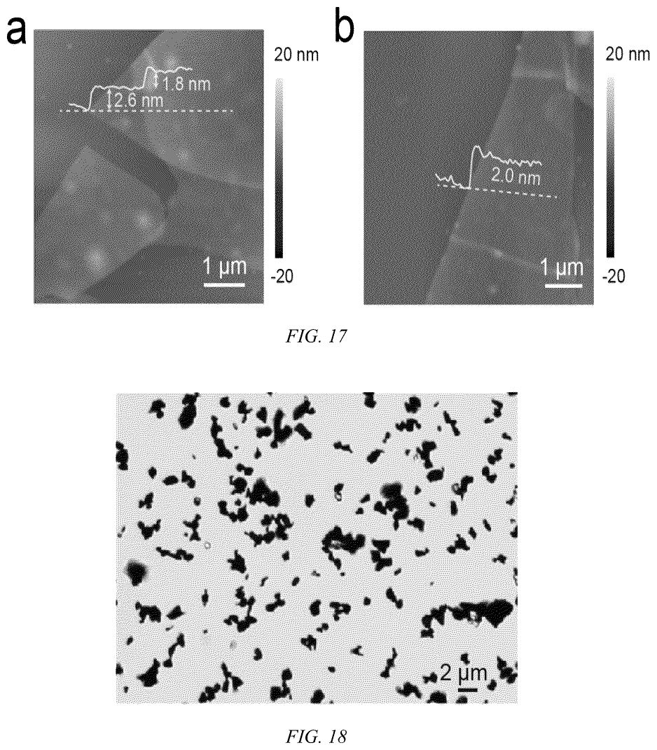

KV₃Sb₅ is a member of the recently discovered quasi-two-dimensional Kagome metal family, with the general formula of AV₃Sb₅ (a: K, Rb, Cs). This material belongs to the P6/mmm space group, with layers connected by chemical bonds between A and V. The Kagome lattice of transition metal atoms is considered an exciting platform for studying a range of electronic correlation phenomena, including charge density waves, anomalous Hall effect, and superconductivity, yielding surprising results. Compared to bulk materials, 2D structures have several advantages: the two-dimensional geometry enhances quantum fluctuations and correlations, and can also promote charge modulation through carrier doping, all of which may alter superconductivity and charge density waves. For example, in CsV₃Sb₅, for a thin sheet with a thickness of 60 nm, the superconducting transition temperature Tc increases from about 2.5 K in bulk to 4.28 K. However, when the sample is further reduced to 4.8 nm, an opposite behavior is observed, with Tc decreasing to 0.76 K. The charge density wave transition temperature shows a trend that is opposite to that of thickness. A recent study reported hole doping by simply exposing the Cs layer to air for a few minutes and utilizing the reactivity of the surface A layer through natural oxidation of the Cs layer. For layers thinner than 82 nm, Tc jumped significantly to about 4.7. The Tc of the K. V₃Sb₅ body is low, 0.93 K, and since the valence electrons on Cs are easily lost, K-related materials may be a better platform for more effectively regulating the carrier concentration. The anomalous Hall conductivity of the thin KV₃Sb₅ crystal (about 105 nm thick) is as high as 15507 ohm⁻¹ cm⁻¹. As for the exfoliation of such materials, it has been reported that conventional and traditional transparent tape methods cannot thin KV₃Sb₅ crystals to the nanometer level (below 100 nm), which is attributed to the chemical interaction between Sb and Cs layers; The size of K is smaller than Cs, which means that the binding interaction in KV₃Sb₅ is stronger, making it more difficult to exfoliate off. Unexpectedly, with the calendering method of the present invention combined with conventional tape exfoliation, KV₃Sb₅ sheet with a thickness of 2-5 nm is obtained, corresponding to 2-5 layers (FIGS. 1c and 17). Even when exposed to air for at least 10 minutes under environmental conditions, the 5.4 nm sheet has a fairly smooth surface. The successful exfoliation of KV₃Sb₅ to a single or fewer layers will provide new opportunities for studying unconventional superconductivity and interactions with charge density waves in two-dimensional Kagome lattices.

Application Example: Place crystal particles flat on the base plate of an electric rolling mill (HZ-2403), and calender them at 200 mm/min in one direction with a single roller to obtain calendered particles. Then use Scotch tape to stick the calendered particles, fold them, press down, and tear to form a thin layer material, which is the two-dimensional nanosheet of this invention. The crystal particles include metallic Bi, metallic Sb, and semiconductor metal oxides SnO and V₂O₅, Bi₂O₂Se, superconducting compound KV₃Sb₅. The obtained two-dimensional nanosheets are similar to those in Embodiment One, including single-layer or fewer-layer exfoliated sheets, with lateral size also reaching 15 μm. This indicates that the method of the present invention not only has versatility for various crystal particles but can also be prepared using industrial equipment, providing a foundation for industrialization.

In summary, the present invention proposes a universal scheme for mechanical exfoliation of various crystal structures with non-van der Waals interlayer forces, including metals (Bi, Sb), semiconductor metal oxides and chalcogens (SnO, V₂O₅, Bi₂O₂Se), as well as superconducting compounds (KV₃Sb₅). Mechanical exfoliation was successfully achieved through simple calendering. The new 2D sheets from non-van der Waals structures exhibit significantly better physical properties compared to bulk crystals; the band gap can be tuned from 0.60 Ev (IR) in bulk SnO to 3.65 eV (UV) in single-layer; the metal-semiconductor (2.01 eV band ap) transition occurs when bulk Sb transitions to a single-layer. The single-layer and fewer-layer KV₃Sb₅ obtained in this work are exciting products of 2D superconductors. This invention proposes a method to mechanically exfoliate non-van der Waals layered structures into high quality 2D analogs for the first time, and opens the door to a new family of materials that are easy to prepare and have potential applications.

Comparative: Conventional tape exfoliation method: Use Scotch tape to directly stick SnO crystal particles (un-calendered), fold and press them, then exfoliate off to form the exfoliated product. FIG. 18 shows an optical microscope image of tape exfoliated SnO sheets collected in transmission mode on a slide substrate, indicating that these layered crystals remain thick and opaque, with thickness at the millimeter level. This suggests that conventional tape exfoliation cannot produce two-dimensional sheets, let alone nanoscale thin sheets.

Metals (Bi, Sb), SnO, V₂O₅, Bi₂O₂Se and superconducting compounds (KV₃Sb₅) cannot obtain sheets with a thickness less than 0.2 μm using conventional classical tape exfoliation methods.

Two-dimensional (2D) materials with a single-layer thickness exhibit many new properties and thickness-related characteristics. Mechanical exfoliation of layered structures is the most effective method for obtaining ultra-thin sheets, but this approach is limited to materials where interlayer interactions are controlled by weak van der Waals forces and does not apply to non-van der Waals structured materials. This invention discloses for the first time a universal method for mechanically exfoliating non-van der Waals structured materials to obtain various novel two-dimensional materials, including metals (Bi, Sb), semiconductor metal oxides, and chalcogenides (SnO, V₂O₅, Bi₂O₂Se) and superconducting compounds (KV₃Sb₅). The method of this invention involves calendering the raw material and then mechanically exfoliation off the structure after sliding using a typical Scotch tape method, resulting in stable single-layer or multi-layer materials with exciting new physical properties. For example, the band gap of metals and semiconductors is modulated over a wide range of layers (Sb ranging from 0 to 2.01 eV, SnO ranging from 0.60 eV (IR) to 3.65 eV (UV)). Several layers of KV₃Sb₅ have also been obtained, which is an exciting material for the study of unconventional superconductivity. The new method of direct mechanical exfoliation of non-van der Waals layered materials in this invention greatly expands the availability of 2D materials to explore their unique physical properties and practical applications.

1. A method for preparing two-dimensional nanosheets, wherein the crystal particles are subjected to calendering treatment and then mechanically peeled to obtain two-dimensional nanosheets.

2. The method for preparing the two-dimensional nanosheets according to claim 1, wherein the crystal particles are non-van der Waals layered crystal particles.

3. The method for preparing the two-dimensional nanosheets according to claim 2, wherein the non-van der Waals layered crystalline particles are metal particles, metal oxide semiconductor particles, metal sulfide semiconductor particles, superconducting compound particles, etc.

4. The method for preparing the two-dimensional nanosheets according to claim 1, wherein the particle size of the crystal particles is in the level of millimeter to millimeter.

5. The method for preparing the two-dimensional nanosheets according to claim 4, wherein the particle size of the crystal particles is 1 μm~5 mm.

6. The method for preparing the two-dimensional nanosheets according to claim 1, wherein the crystal particles are laid flat and then subjected to calendering treatment, and then mechanically peeled to obtain two-dimensional nanosheets.

7. The method for preparing the two-dimensional nanosheets according to claim 1, wherein a roller or rod is used for calendering treatment; mechanical exfoliation is tape exfoliation.

8. Two-dimensional nanosheets are prepared according to the method of preparing two-dimensional nanosheets as claimed in claim 1.

9. The two-dimensional nanosheets according to claim 8, wherein the thickness of the two-dimensional nanosheet is 0.1 nm to 50 nm.

10. An application of the two-dimensional nanosheets as claimed in claim 1 in the preparation of two-dimensional nanosheet assembly materials.
